(19) United States
(12) Patent Application Publication
(10) Pub. No.: US 2012/0303853 A1
(43) Pub. Date: Nov. 29, 2012

(54) ENGINEERING OF A DATA COMMUNICATION

(75) Inventors: MARTIN BRUX, Oberreichenbach (DE); KAI GÄBEL, Neukirchen (DE); KLAUS HERMES, Geltendorf (DE); MARTIN KIESEL, Poxdorf (DE); RAIMUND KRAM, Erlangen (DE); RAINER MÖHRING, Rothlein (DE); MANFRED POPP, Zirndorf (DE); HAIKO SCHMIDT, Chemnitz (DE); ANDREAS UHL, Heroldsbach (DE)

(73) Assignee: Siemens Aktiengesellschaft, Munchen (DE)

(21) Appl. No.: 13/302,425

(22) Filed: Nov. 22, 2011

(30) Foreign Application Priority Data
Nov. 23, 2010 (EP) EP10192253

(51) Int. Cl. G06F 13/14

(52) U.S. Cl. 710/305

(57) ABSTRACT

In a method for communication between function modules in the field of automation systems, a first function module has a first communication interface, and a second function module has a second communication interface. The first communication interface is assigned to the second communication interface, and the assignment is stored.

### CROSS-REFERENCES TO RELATED APPLICATIONS

This application claims the priority of European Patent Application, Serial No. EP10192253, filed Nov. 23, 2010, pursuant to 35 U.S.C. 119(a)-(d), the content of which is incorporated herein by reference in its entirety as if fully set forth herein.

### BACKGROUND OF THE INVENTION

The present invention relates to engineering of a data communication in an industrial automation environment.

The following discussion of related art is provided to assist the reader in understanding the advantages of the invention, and is not to be construed as an admission that this related art is prior art to this invention.

Various data communication methods are known in the field of industrial automation systems. These relate to communication bus systems (e.g. Profibus, Ethernet, CAN bus, etc.), sensor interfaces, I/O interfaces, etc. An engineering system can be used for planning such a data communication. When configuring the data communication, e.g. logical addresses are allocated. The engineering system can also be designed such that a planner specifies addresses and/or protocol utilization for a bus system. This is usually done by using alphanumeric characters in an engineering system or in a runtime system of the automation. The automation relates e.g. to the automation of a machine tool, a press, a printing machine, a packing machine, a hoist, a robot, etc.

It would therefore be desirable and advantageous to obviate prior art shortcomings and to provide a simpler approach for engineering a data communication.

### SUMMARY OF THE INVENTION

According to one aspect of the present invention, a method for communicating between function modules of automation systems, wherein a first function module has a first communication interface and a second function module has a second communication interface, includes the steps of assigning the first communication interface to the second communication interface, and storing the assignment.

A user of an engineering system can thus be provided with a simple, transparent, type-assured, symbolic assignment of interfaces of objects that are located on the same system or in particular on a different system. The engineering system or indeed another system can be used in this case to set up the communication between function modules within a device or between function modules of different devices, wherein communication takes place in particular across a system. In this case, devices are in particular automation components such as a stored programmable control (SPC), a motion control unit, an I/O module, a power converter, a master computer, etc. For example, a simple transparent and yet flexible assignment of I/O points, terminals, or axes of drive objects which are located on integrated or separate systems can thus advantageously be attained.

By abstracting the communication connections between communication interfaces, it is no longer necessary e.g. to define a manual assignment via storage in a peripheral section, e.g. by specification of the logical address, or by means of a fixed assignment in a standalone system.

Using a method for communication between function modules in the field of automation systems, a first function module has a first communication interface. In particular, the function module is a software module which has a specific function (e.g. a technology module, a regulator module, a drive module, a logic module, etc.). The function module has a communication interface, wherein the function module can exchange data, e.g. with other modules, via the communication interface. Communication interfaces may be of different types, wherein interfaces that are connected together are of a compatible or identical type. A second function module therefore has a second communication interface, wherein the first communication interface is assigned to the second communication interface, wherein the assignment is stored. In this case, the assignment is effected e.g. by means of a graphical system (e.g. an engineering system, programming system, monitoring system, etc.). In this case, it is e.g. possible graphically to connect two communication interfaces by means of a mouse pointer in order to indicate or program a communication connection. The system advantageously checks whether the types correspond and accepts or rejects the association, or outputs a report which indicates a different or incompatible type. The communication interfaces relate to different function modules, wherein the function modules can nonetheless be provided, programmed and/or executed in the same automation component or in a different automation component.

According to an advantageous feature of the present invention, the first function module is assigned to a first automation component and the second function module is assigned to a second automation component.

According to an advantageous feature of the present invention, the communication interface or communication interfaces may be parameterized and/or modeled. A user may adapt interfaces to the requirements concerned. If function modules are based on objects of different types, these object types are implemented in the context of programming. The respective types also feature a description of possible interfaces. When implementing the object, it is advantageously possible to set the interfaces which the object is to have. This depends on e.g. the function that is to be executed in each case. For example, it is possible to implement an object which has one, two, three or more sensor interfaces.

According to an advantageous feature of the present invention, the relative assignments of the interfaces to each other may be used to automatically parameterize bus-based communication between automation components and/or to automatically assign logical address ranges.

According to an advantageous feature of the present invention, the communication is parameterized depending on the parameterization and/or modeling of the communication interfaces. For example, if two sensor interfaces have been implemented for a function module, a corresponding transmission channel is reserved for them.

According to another advantageous feature of the present invention, this may also be managed differently. For example, a corresponding communication (e.g. a channel, or a space in a bus protocol) may be provided only if sensor interfaces are connected together. This provision of communication connections (addresses and/or bandwidth) takes place automatically. A user consequently has less work.

According to an advantageous feature of the present invention, a connector is provided for assigning the communication interfaces, wherein the connector features interconnection information. This can likewise simplify the task of programming communication connections. For example, there may be different types of communication interfaces and connectors, wherein only interfaces and connectors of the same type are compatible and may be used together.

According to an advantageous feature of the present invention, a communication bus system is assigned to an automation component or to two automation components. Depending on the bus type, the communication connections between the various function modules of different automation components may be automatically integrated into the bus system.

According to an advantageous feature of the present invention, an assignment of communication interfaces is rejected and/or flagged if the communication bus system is not able to satisfy the communication demand that is required for too many communication connections between the automation components.

According to an advantageous feature of the present invention, modeling data is generated by means of an object-specific script, wherein the function module represents an object. Such a script may be executed in conjunction with an implementation of a function module, for example.

The graphical assignment of communication connections additionally results in e.g. a simplified assignment of I/O points to I/O interfaces. For these and other communication interfaces, the following procedure or at least one of the following steps may be performed in this case:
definition of an automation system
   comprising the introduction and description of I/O interfaces for I/O variables or for the external interfaces of technological objects;
   comprising the introduction and description of I/O interfaces (communication interfaces) for the I/O points on the same automation system or also for the I/O points on I/O modules that are attached via a communication system, and optionally the modeling of the external interfaces (communication interfaces) of SW objects on intelligent I/O modules, e.g. the external interfaces of drive objects as per PROFIdrive profiles;
interfaces are modeled (e.g. in respect of designation, type, properties, attributes, actual information (existing interconnection, not yet interconnected, etc.));
the modeling data is generated by means of scripts that are specific to an object type, wherein the object-specific script files are supplied in particular for the objects, modules and components or in the dedicated engineering system;
on the basis of the modeling data, compatible ‘partner’ interfaces may be selected and assigned in a type-assured manner for a selected I/O interface, wherein in particular only type-compatible interfaces may be interconnected;
the interfaces are given symbolic names in this case, and are therefore easier for the user to select/assign and manage;
the selection process is further supported by modeled properties of the interfaces;
the terminal designation may also be modeled as an attribute at the interface;
the assignments are preserved and stored by means of connectors or links;
the internal communication is determined by the system on the basis of the assignments and the functions that have been set, wherein in particular one of the following steps is performed in this context: automatic telegram setup, automatic communication configuration (e.g. specification of the PROFIdrive telegram, telegram extension and/or logical addressing).

The user therefore works on a technological and symbolic level, and not in the logical address range. The logical address range is advantageously concealed.

The communication is established by the system in accordance with the interface interconnections and the functionality that has been set (communication environment (logical address range) and communication content (telegrams)). This is done e.g. by means of an implicit process (e.g. by implementing the engineering plan) or on the basis of an explicit action.

According to an advantageous feature of the present invention, a function module relates to a motion control unit, wherein speed pre-control, position regulator gain and the difference between desired and actual position are sent to the drive as control-relevant signals using a DSC method. These signals may advantageously be combined in a single interface and form an interface type. Only interfaces of this type can then be connected together. The drive, which features a module having an interface of this type, then generates the true desired value for the position. In this case, the position control takes place in the drive. The effective contouring error is simulated in the control when using the DSC method.

In order to allow clear representation and simple modification and/or correction of I/O interface interconnections, a suitable tool may be provided for a user. This is used for the purpose of clearly representing the interconnection of interfaces and optionally modifying/correcting the interconnections, these communication interfaces (i.e. the I/O interfaces) being modeled using I/O interface description data. Such a tool (system for the administration of communication connections) may have e.g. at least one of the following functions:
a representation of the output interface and the currently interconnected partner interfaces,
display of the I/O interface type,
identification of non-interconnected output interfaces i.e. currently missing partner interfaces,
identification of ‘released’ partner interfaces, e.g. due to the partner being removed from the plan;
identification of modifications to the interconnection information, e.g. due to renaming of the output interface or of the interconnection partner,
simple repair of faulty (incorrect) interconnections by entering valid, type-compatible interfaces,
a simple specification of the interconnection partner by means of alphanumeric label specification,
creation of interconnections by calling a subprogram, and
displaying the interface type of the individual interconnections.

In this case, functions such as display interconnection, edit interconnection, and correct interconnection can be realized in a tool or in various tools. In this case, the use of a graphical service is particularly advantageous to the user, since this results in clear representation, ease of editing, modifying and correcting interface interconnections (i.e. assignments), and may be based on the I/O interface modeling and I/O interface interconnection in the automation systems. The description data (e.g. symbolic labels, type information, etc.) can aid the user during the interconnection of interfaces.

A simple functional/technological selection and assignment of I/O interfaces and components are important for a user, and should be independent of any possible restricted communication width. This relates to e.g. the simple technological assignment of the sensors in a motion control unit, even if these are transmitted e.g. in a PROFIdrive telegram having a maximum of only two sensor channels. It should be possible to conceal the assignment to the internal sensor channels, even if the sensors can be planned flexibly. It is thus possible to prevent a direct assignment to the corresponding communication channel/address range (e.g. to sensor 1 or sensor 2 in the PROFIdrive telegram). The direct technological assignment of a technological I/O interface (i.e. a technological communication interface) to a specific type-compatible I/O point, even without direct assignment to a communication interface, is possible by means of the abstraction described above. Therefore e.g. the sensor in the automation system may be assigned to a corresponding sensor in a peripheral component.

By means of introducing and evaluating technological attributes, the communication interface can be concealed while the assignment is nonetheless definitive. It is no longer necessary for the user to specify the explicit communication channel.

The management of sensor signals is one example for such an attribute. For example, the first communication channel in an automation system may only ever be used to transmit the sensor of the drive control, usually the motor sensor; if such a technological criterion is defined at the interface, it is no longer necessary to specify the communication channel when the motor sensor of the axis is being interconnected to a drive.

By virtue of the definitive assignment of interfaces in the context of limited communication width, it is also possible to manage with a limited number of communication channels, this being achieved by introducing and applying suitable technological attributes. For example, selected communication channels may only be assigned to selected interfaces if corresponding technology-related attributes are present. In this case, a limited communication width or indeed a limited number of communication channels may be concealed by assigning the interfaces via technological attributes that allow a definitive mapping onto the channels. The workload on the user of an automation system may be reduced by concealing internal communication specifications or internal communication conditions, thereby reducing the external view of the technology to assignments in the symbolic field. The user models interfaces, wherein technological attributes are defined in a suitable manner and the attributes are used for the simplification of the user view and assignment of the communication channels via the system. Attributes may be used in particular for the sensor assignment in the case of objects which transmit the sensor data by means of a PROFIdrive telegram.

If a communication is to be programmed or parameterized by sensor data, without logical addresses being allocated by a user personally, this may take place as follows for example. In the context of a method that is provided for this purpose for communication between function modules in the field of drive system engineering, wherein a first function module has a first sensor interface, wherein a second function module has a second sensor interface, the first sensor interface is functionally assigned to the second sensor interface. This is done by means of a graphical user interface, for example. Interfaces of the function modules are associated together in this case. In particular, the first function module may be assigned to a first automation component and the second function module may be assigned to a second automation component in this case. In particular, an address (in particular a logical address) for transferring sensor data between the two different automation components is specified automatically in this case. The communication between the automation components is supported by a bus system for transmitting data.

According to an advantageous feature of the present invention, the first function module is an axis module, the second function module being a drive module in particular. Therefore the first automation component may be a control device and/or a regulating device, in particular a motion control unit, and the second automation component may be a power converter.

According to an advantageous feature of the present invention, the axis module is based on an axis object that is implemented, wherein the axis object has description data for interfaces, wherein interface data is generated by the implementation, wherein the first sensor interface is an item of interface data.

According to another advantageous feature of the present invention, the drive module may be based on a drive object that is implemented, wherein the drive object has description data for interfaces, wherein interface data is generated by the implementation, wherein the second sensor interface is an item of interface data.

According to another advantageous feature of the present invention, the sensor interfaces may be graphically associated. If the sensor interfaces are of different types, in the case of an association of sensor interfaces of different types, an association is automatically rejected and/or an incorrect association is indicated. If the interfaces are of the same type, the association is accepted by the system. The system is e.g. an engineering system.

According to yet another advantageous feature of the present invention, the automatically specified logical address of the bus communication may be used for sensor signals. In this case, the logical addresses for the bus communication can change automatically if communication interfaces (in particular sensor interfaces) are changed. This applies if sensor connections are deleted or new sensor connections are created, for example.

According to an advantageous feature of the present invention for communication between function modules in the field of drive system engineering, a first function module of an automation system may have a multiplicity of sensor interfaces, wherein a second function module (11) of a peripheral component may also have a multiplicity of sensor interfaces. A data connection between the automation system and the peripheral component is provided by means of a communication bus, wherein the peripheral component has hardware ports for a multiplicity of sensors, these being connected to the peripheral component individually and not jointly via a shared bus. The hardware ports in the peripheral component are associated at least in terms of data with the sensor interfaces of the peripheral component, wherein the sensor interfaces relate to a communication bus in particular.

According to an advantageous feature of the present invention, the bus may have a bus protocol for a multiplicity of sensors and at least one actor, wherein one of the connected sensors is a motor sensor.

Simple symbolic interconnection of I/O interfaces (i.e. communication interfaces) via a suitable tool represents an important possibility for users. Software may be provided for this purpose, thereby providing at least one of the functions described below for the interconnection of interfaces:
an input variable for the software is an I/O interface or external interface of a technological object, also referred to below as an “interface to be interconnected”, which must be interconnected to another type-compatible I/O interface on the same device or on another device, subsequently referred to as a “partner interface”, wherein I/O interface description data is available for both interfaces,
the I/O interfaces are displayed using symbolic labels,
type-based selection lists are displayed for the selection of the partner interface,
also indicated is whether the destination interfaces are already interconnected, and whether the destination interfaces possibly offer multiple interconnection,
properties relating to the interface to be interconnected and properties relating to the destination interface are displayed,
the interface type is displayed,
if the type of the interface to be interconnected is contained in a superordinate type, e.g. element in a structure, or type “bit” or “BOOI” in a BYTE, WORD, the corresponding substructures, elements, contained data types may be navigated;
in the case of corresponding further modeling, settings for the partner interface may be activated directly from the interconnection tool,
if I/O description data is not available for an I/O interface, the specification of the direct communication storage may also take place via the specification of the storage address or logical address.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows communication interfaces with description data according to the present invention;

FIG. 2 shows a connector interconnection according to the present invention;

FIG. 3 shows script processing according to the present invention;

FIG. 4 shows an automation component according to the present invention;

FIG. 5 shows a first interconnection between components according to the present invention;

FIG. 6 shows a second interconnection between components according to the present invention;

FIG. 7 shows interconnection data processing according to the present invention;

FIG. 8 shows a first screen display of interconnections;

FIG. 9 shows a second screen display of interconnections;

FIG. 10 shows a third screen display of interconnections;

FIG. 11 shows a first interconnection of a multiplicity of sensor data;

FIG. 12 shows a second interconnection of a multiplicity of sensor data;

FIG. 13 shows the underlying structure of an interconnection check;

FIG. 14 shows an axis configuration; and

FIG. 15 shows a representation of an output reference.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

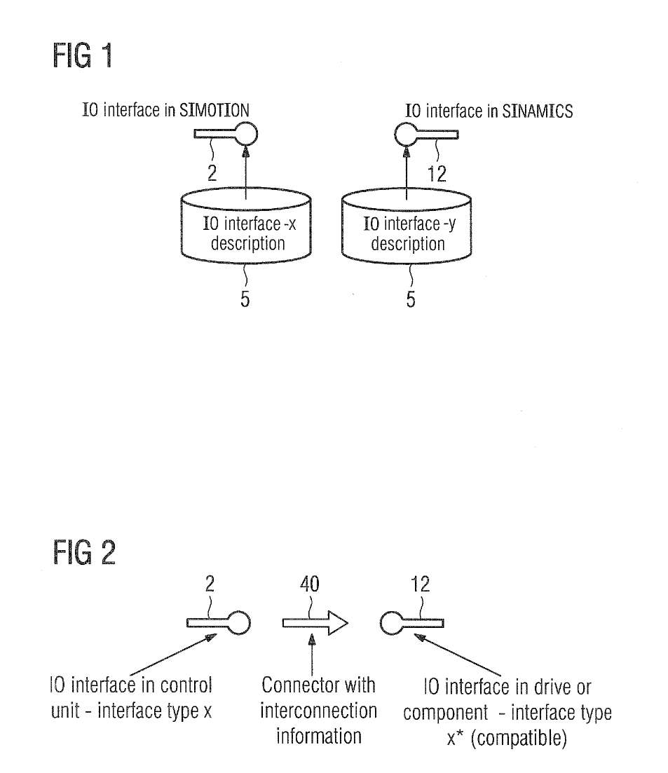

Turning now to the drawing, and in particular to FIG. 1, there is shown a first communication interface 2 and a second communication interface 12. Both communication interfaces have description data 5: I/O interface-x description and I/O interface-y description. As represented in FIG. 2, the interfaces 2 and 12 can be symbolically connected by means of a connector 40. According to FIG. 2, the first interface 2 relates to a control unit and the second interface relates to a drive, wherein both interfaces are of the same type x and can therefore be connected together.

By virtue of using such communication interfaces 2, 12 with type descriptions, various advantages can be achieved as follows, for example:
simple transparent type-assured symbolic assignment of I/O points to I/O interfaces of objects that are located on the same components or in particular on different distributed components,
a simple method for transparent and type-assured symbolic assignment of I/O points to local and/or distributed I/O interfaces in automation systems, by means of:
   modeling the I/O interfaces
   type-assured interconnection of the I/O interfaces
   establishing the internal communication from the modeling data and the interconnection information using the system;
automated generation of the modeling data for the interfaces by means of script files,
automatic provision of the script data with the components or modules, or availability in the engineering system,
generation of the I/O description data from data, parameters, current settings of the objects and components,
use of the I/O interfaces as I/O variables in an automation system, or also external interfaces of individual objects, in particular technological objects,
storage of the connectors (comprising the assignment information of the I/O interfaces) with a plan
the type-based interfaces are also applied on automation systems which only exchange data using the logical address range in the runtime system, if the conversion of the symbolic assignment, and the specification of the communication and the logical addresses takes place in the engineering system;
optional storage of the symbolic assignments in the runtime system for readout by an HMI operating system,
diagnostic display of objects (with connectors) and assignments in lists or graphically, and/or
re-planning of properties and attributes with reference to the graphical interconnection.

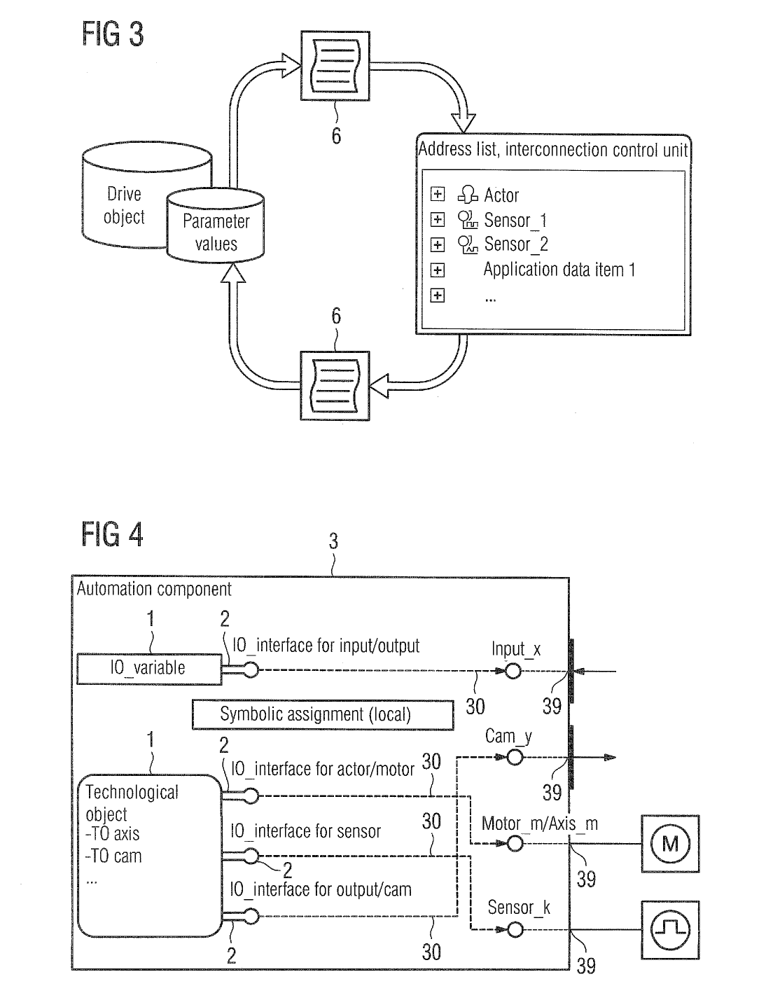

The illustration according to FIG. 3 shows the use of script files 6 for generating I/O modeling data. Object data, parameter data and/or readable properties and description data are used for this purpose. This is represented in FIG. 3 using the example of a drive object. Taking the address list as a starting point, a second script 6 optionally also allows a telegram to be set on the basis of the interfaces required by a user. The circuit to the parameter data is closed thus. For example, the following description data can be required in relation to type for a drive object:
description of all possible interfaces and possible properties (maximum configuration),
script for determining current interfaces from parameter values, and
script for setting the telegram on the basis of required interfaces (optional).

The illustration according to FIG. 4 shows a symbolic assignment using the I/O interface modeling. A first automation component 3 is represented here, e.g. a control unit. User I/O interfaces 2 and hardware interfaces 39 are located on the same component here. For example, a motor M and a sensor are attached to the hardware interfaces 39. The hardware interfaces 39 are symbolically assigned via connections 30. In this case, the assignment relates to e.g. a first function module 1, which is a technology object (e.g. the technology object cam or the technology object axis). The hardware interfaces 39 at the represented I/O points relate to e.g. inputs, outputs, actor/motor/drive, and/or sensor as illustrated.

Advantageously, the interfaces can be modeled in a variable manner, due to the introduction of connectors for the interconnection of the interfaces in the engineering system in particular. This allows technological system modeling in relation to I/O interfaces and system communication. In the context of the interconnection process, the user is supported e.g. in that only type-compatible interconnections are permitted from interconnection points that are still free. The system communication is created from the interconnection, modeling and possibly supplementary rules, wherein the internal communication and associated settings can be concealed from the user. The modeling and the graphical connector interconnection can be used for application-specific and technology-compatible engineering, such that planning of assignments is possible on a user-specific technological level.

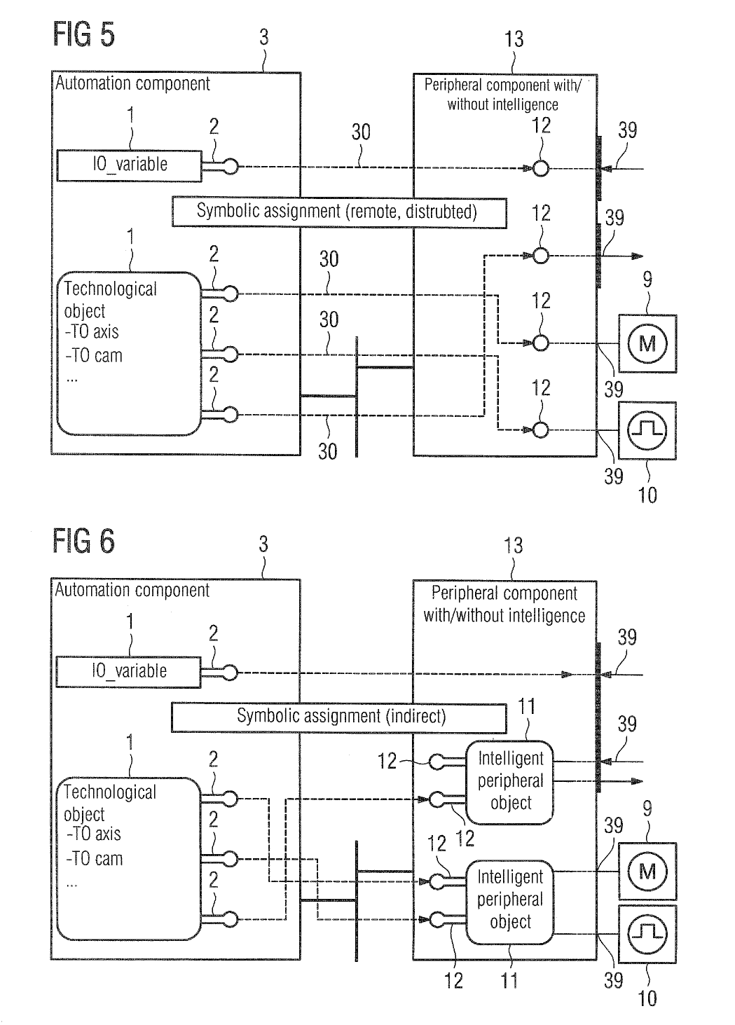

The illustration according to FIG. 5 shows two automation components 3, 13. The first automation component has a technology object 1 as a function module. The module has interfaces 2, which are connected via connectors 30 to I/O points 12, i.e. interfaces of a further component 13. The component 13 is a peripheral component, to which hardware such as a sensor 10 or a motor cable of a motor 9 is attached via hardware interfaces 39. The connectors 30 between the components 3 and 13 are represented by broken lines. The real bus between the components 3 and 13 is indicated by a network structure with branches to the components, and is represented by means of continuous lines. FIG. 5 shows a distributed assignment to I/O points 12 as interfaces, wherein the interfaces 12 are directly assigned to hardware ports 39. The illustration according to FIG. 6 differs from that in FIG. 5 in that the assignment takes place indirectly. This means that the interfaces 2 of the modules 1 of the component 3 are at least in some cases first connected to interfaces 12 of the modules 11 of the component 13. This relates to an intelligent peripheral object in this case. These modules 11 are then associated with ports 39 of the component 13.

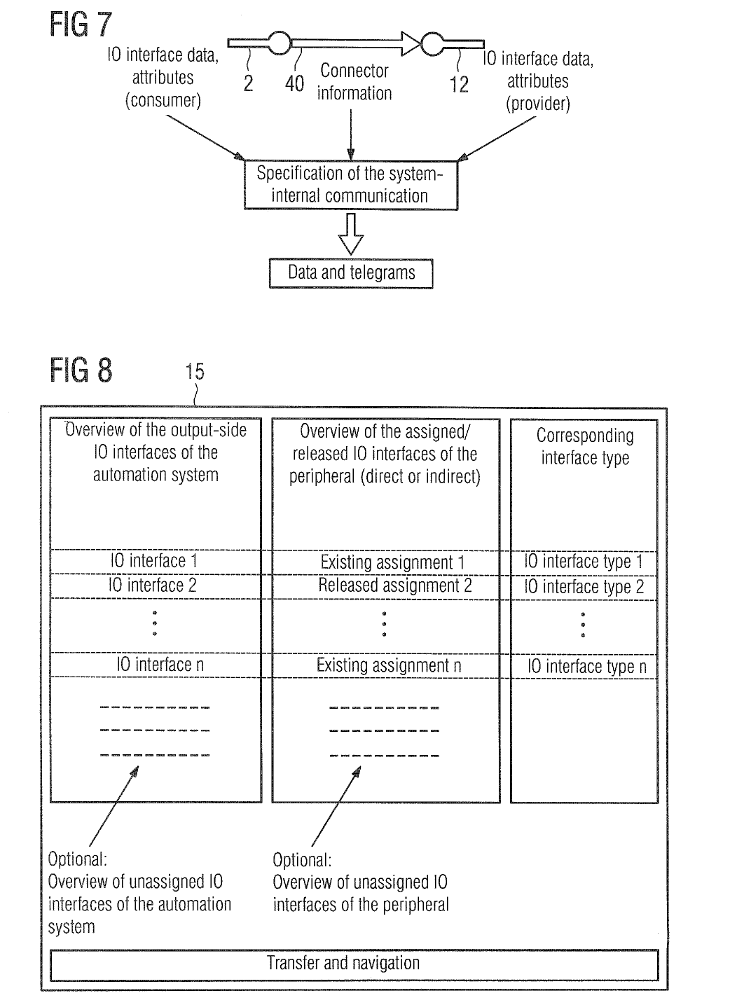

The illustration according to FIG. 7 shows interfaces 2 and 12, which are connected via a connector 40. Information data (in particular type-specific information data) is assigned to both the interfaces 2 and 12 and the connector 40. The system-internal communication is determined on the basis of this information. Data relating to the telegram structure for the bus between automation components is then derived therefrom.

The illustration according to FIG. 8 shows a screen display 15, which offers a user an overview of interconnections. This also allows the user to make corrections to interconnections.

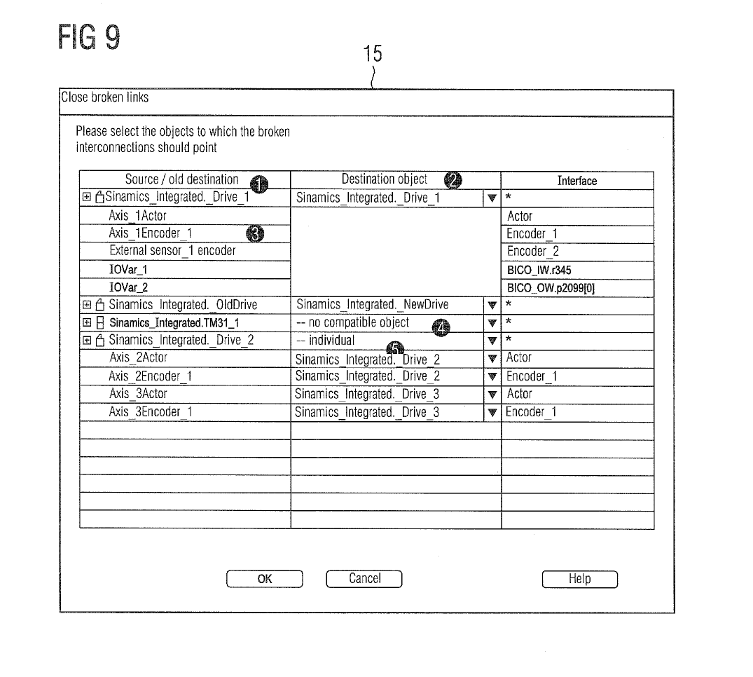

The illustration according to FIG. 9 shows a further screen display 15 for interconnections of interfaces. Marker points 1 to 5 describing the aim or function of the respective displays have been provided to aid understanding:
1. Displayed here is the name of the object to which an interconnection (link) has been lost (old destination that is no longer connected).
2. Specified here is the destination object, i.e. the object to which a new interconnection is to be established. This can be done globally for a complete drive object (actor, encoder_1, encoder_2, BICO, etc.) as represented in the first rows or individually for each interface (as represented in the last five assigned rows). However, the system does not have to make a preselection for this purpose.
3. Illustrated here is an expanded tree for the Drive_1. This makes it possible to identify which interconnections have been newly connected. In this case, the left-hand side (source) shows e.g. the interface of a motion control unit, while the right-hand side (destination) shows the interface below the object whose interconnections are to be reestablished.
4. There is an entry in the selection list in the event that no compatible object exists; if this entry is selected, the relevant interconnections remain unchanged.
5. A user can advantageously interconnect every interface individually if necessary.

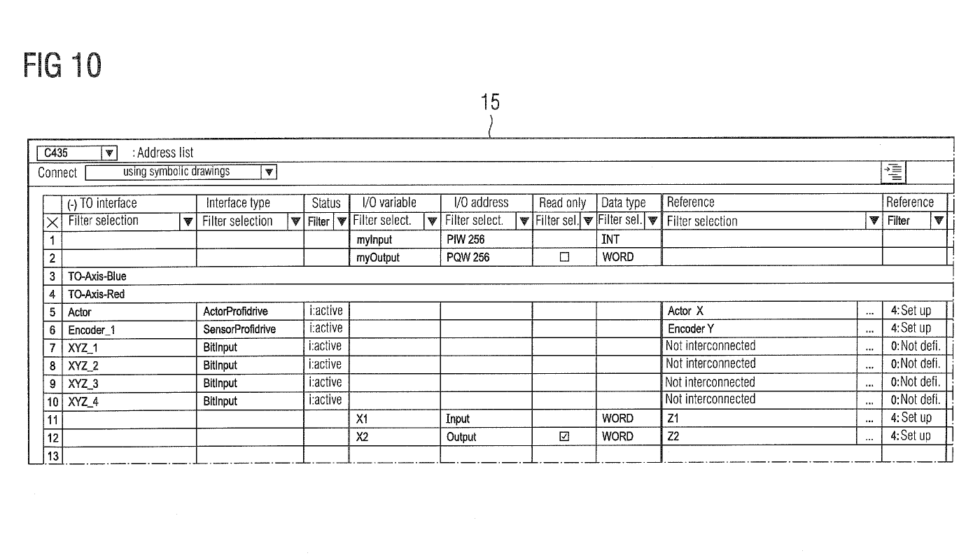

The illustration according to FIG. 10 shows a further possible screen display for representing interconnection information.

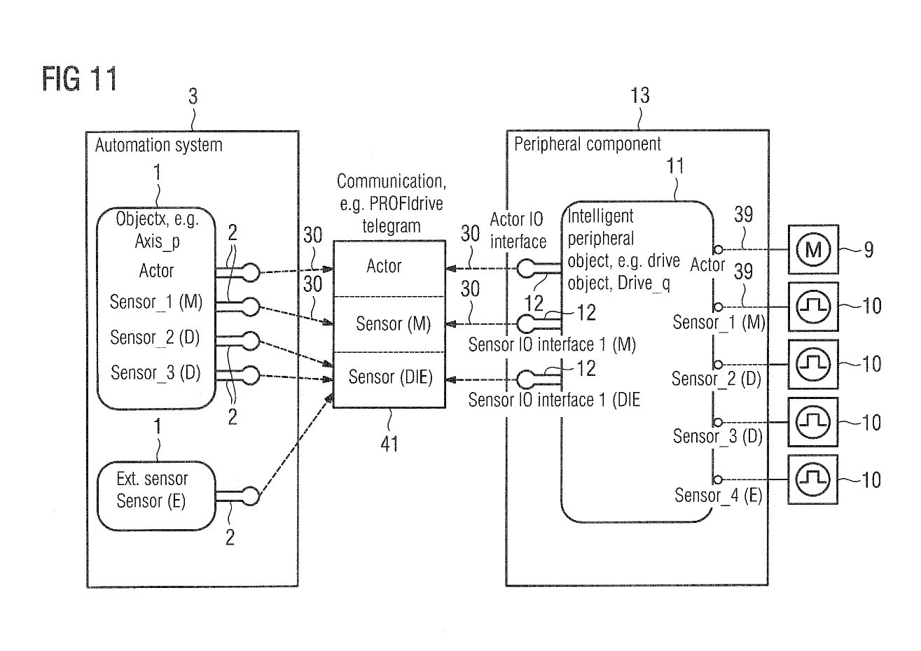

The illustration according to FIG. 11 shows an example for an interconnection of sensor data. Illustrated here is an axis object 1, which has interfaces 2 for one actor and three sensors. A further object 1 for an external sensor is also present. The interfaces 2 are transmitted from the first automation component 3 to the second automation component 13 via an automatically generated telegram. The second automation component 13 is a peripheral component, which has ports 39 for a motor 9 and sensor 10. The ports 39 are associated with the interfaces 12 in a function module 11 which is programmed as an object.

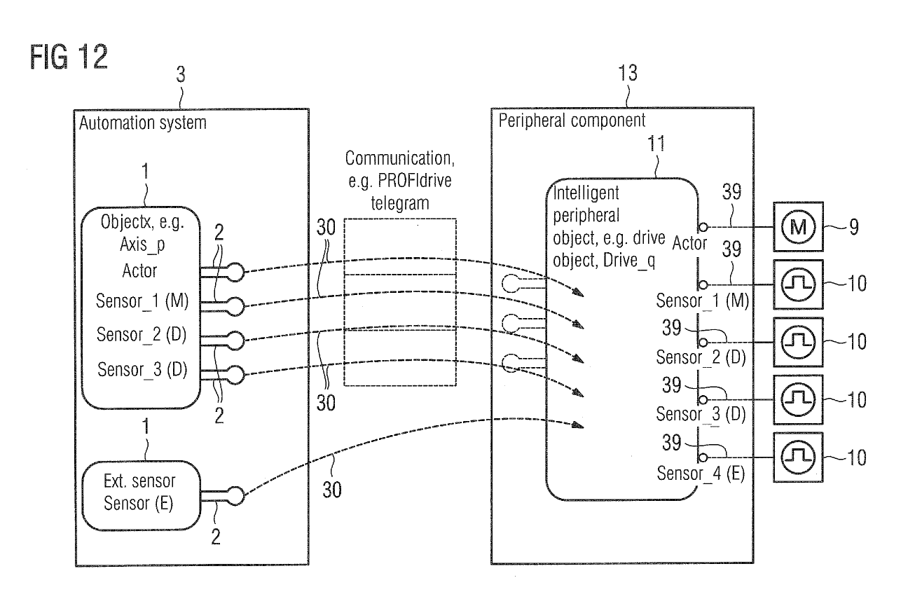

Further to FIG. 11, the illustration according to FIG. 12 shows that the interconnection 30 between the components 3 and 13 is made graphically. The following assignments are derived therefrom:

The Axis_p is assigned to the Drive_q (axis/actor interconnected by the system).

The Axis_p_Sensor_1 is likewise assigned to the Drive_q (Motor_Sensor_1(M) is interconnected to sensor I/O interface 1 by the system).

The Axis_p_Sensor_2 is likewise assigned to the Drive_q (direct sensor is interconnected to sensor I/O interface 2 by the system).

The Axis_p_Sensor_3 is likewise assigned to the Drive_q (direct sensor is interconnected to sensor I/O interface 2 by the system).

The external sensor is assigned to the Drive_q (external sensor is interconnected to sensor I/O interface 2 by the system).

For the interconnection of sensor data across two components 3, 13, objects 1, 11 having interfaces are therefore provided in each component, wherein the interfaces can be graphically associated without specifying addresses, and the addresses and telegram generation can be determined automatically from the interface information. For the interconnection of interfaces, provision is made in particular for description data such as symbolic labels, type information, etc.

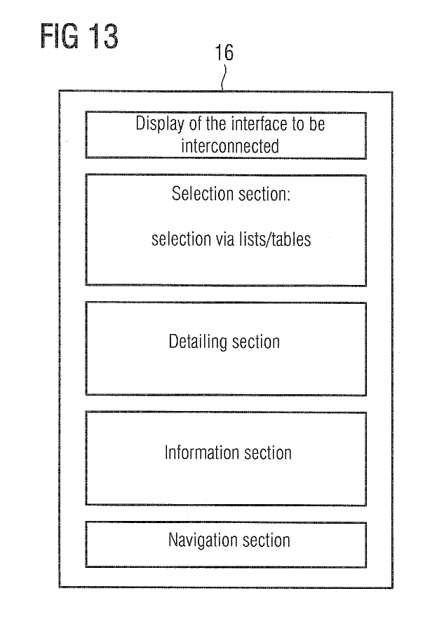

The illustration according to FIG. 13 shows a structure for interconnection monitoring, illustrating the possible segments in a representation 16 of this type.

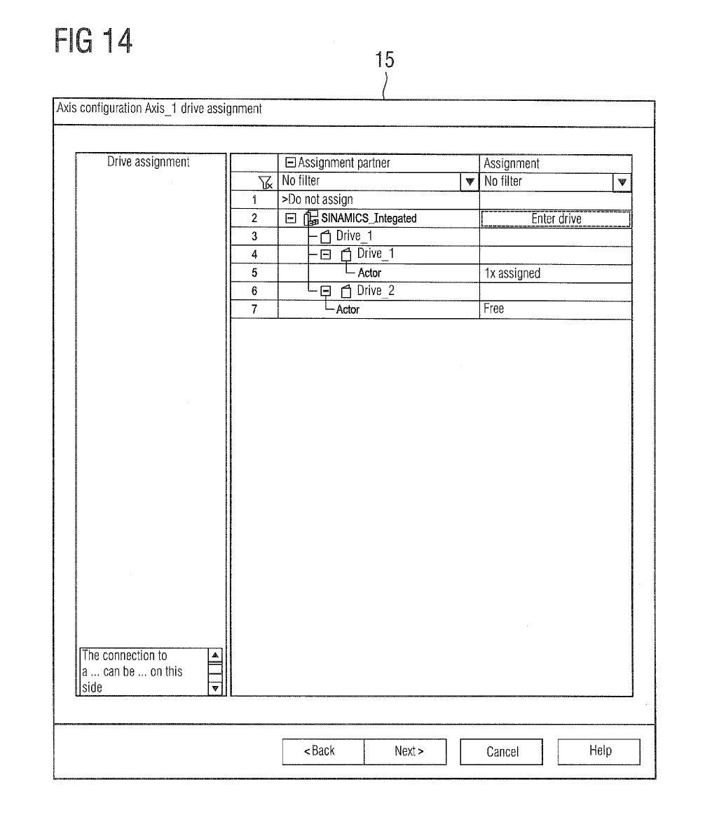

The illustration according to FIG. 14 shows how an axis configuration and a drive assignment can be represented on a screen 15 for a user. Interconnections of an axis can be presented in a simple manner thus.

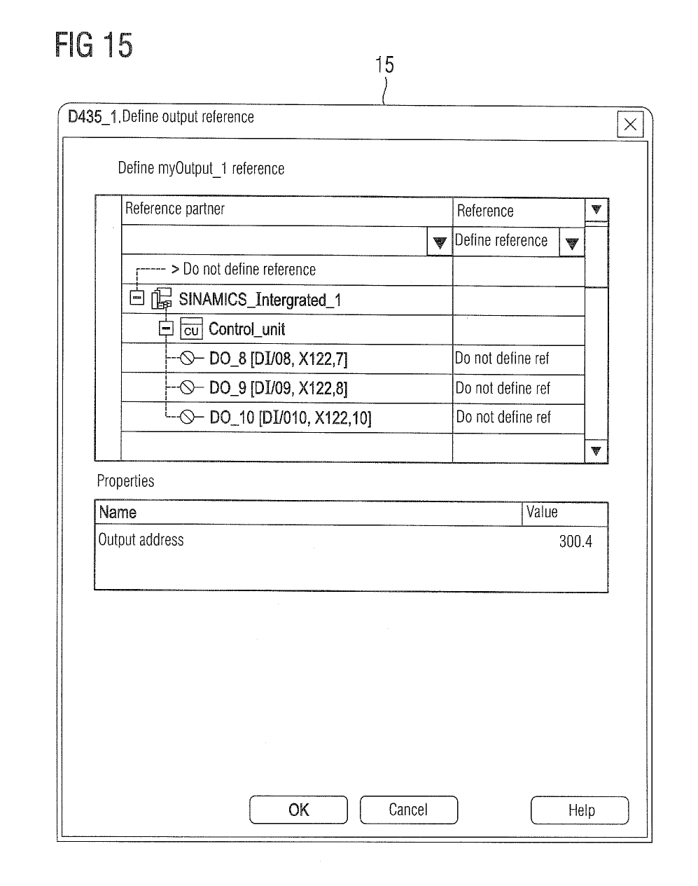

The illustration according to FIG. 15 shows an example of an interconnection of I/O points.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for communicating between function modules of automation systems, wherein a first function module has a first communication interface and a second function module has a second communication interface, comprising the steps of:
assigning the first communication interface to the second communication interface, and
storing the assignment.

2. The method of claim 1, wherein the first function module is assigned to a first automation component and the second function module is assigned to a second automation component.

3. The method of claim 1, wherein the first communication interface and the second communication interface are parameterized.

4. The method of claim 1, wherein the first communication interface and the second communication interface are modeled.

5. The method of claim 2, wherein the first automation and the second automation component communicate via a bus, wherein the communication bus between the first automation and the second automation component is parameterized based on the assignment.

6. The method of claim 2, wherein logical address ranges are automatically allocated based on the assignment.

7. The method of claim 5, wherein the communication bus is parameterized depending on a parameterization of the first communication interface and the second communication interface.

8. The method of claim 5, wherein the communication bus is parameterized depending on modeling of the first communication interface and the second communication interface.

9. The method of claim 1, wherein the first communication interface is assigned to the second communication interface by way of a connector comprising interconnection information.

10. The method of claim 2, wherein the first automation component and the second automation component communicate with each other via a communication bus system.

11. The method of claim 10, wherein the assignment of the first and second communication interfaces is rejected or flagged, or both, if the communication bus system is unable to meet a predetermined communication requirement.

12. The method of claim 4, wherein data for modeling the first communication interface and the second communication interface are generated by means of an object-specific script, with the first function module and the second function module each representing an object.
